(19) United States
(12) Patent Application Publication
(10) Pub. No.: US 2024/0201419 A1
(43) Pub. Date: Jun. 20, 2024

(54) SPATIAL OPTICAL COMMUNICATION SYSTEM, ANALYSIS APPARATUS AND ANALYSIS METHOD

(71) Applicant: NEC Corporation, Tokyo (JP)

(72) Inventor: Hiroshi Imai, Tokyo (JP)

(73) Assignee: NEC Corporation, Tokyo (JP)

(21) Appl. No.: 18/534,797

(22) Filed: Dec. 11, 2023

(30) Foreign Application Priority Data
Dec. 14, 2022 (JP) 2022-199581

(51) Int. Cl. G01W 1/14; G01H 9/00; G01V 1/24

(52) U.S. Cl. CPC G01W 1/14; G01H 9/00; G01V 1/24; H04B 10/07

(57) ABSTRACT

A spatial optical communication system includes: a plurality of optical transmitting and receiving apparatuses capable of constituting a mesh spatial optical communication network; and at least one processor, the at least one processor carrying out an analysis process of inferring, on the basis of reception signals of the optical transmitting and receiving apparatuses, a state of an air environment in at least one portion of an area in which the spatial optical communication network is formed, or a state of an installation ground of each of the optical transmitting and receiving apparatuses in the at least one portion of the area.

This Nonprovisional application claims priority under 35 U.S.C. § 119 on Patent Application No. 2022-199581 filed in Japan on Dec. 14, 2022, the entire contents of which are hereby incorporated by reference.

### TECHNICAL FIELD

The present invention relates to a spatial optical communication system, an analysis apparatus and an analysis method.

### BACKGROUND ART

Various techniques for ascertaining environmental states such as weather and earthquakes have been conventionally known. A typical example of a technique for ascertaining weather is a technique using a meteorological radar. Specifically, on the basis of a rain pattern recognized from reflection intensities (echo intensities) obtained by a meteorological radar and actually measured rainfalls, a rainfall at a given point is estimated by computation. Observation data of actual rainfall at each of observation points is collected by Automated Meteorological Data System (AMeDAS). For rainfall measurement, the observation data is used. The observation data is collected from rain gauges installed in several places in one city. The several places correspond to predetermined blocks (17 km mesh) obtained by dividing the one city. In a case where the rainfall is estimated, computation is carried out with use of the echo intensities and the observation data of the rainfall.

Patent Literature 1 discloses a rainfall estimation system including: a meteorological radar that is provided at a predetermined point in a rainfall estimation target region and that outputs rain intensity distribution information; a rain gauge that is provided at each of a plurality of observation points in the rainfall estimation target region and that outputs rainfall information; a neural network that learns a relationship between training signals and input signals at rainfall observation points, the input signals being the rain intensity distribution information from the meteorological radar and the training signals being the rainfall information from the rain gauge, and that also estimates a rainfall at a given point in the rainfall estimation target region, according to the aforesaid relationship on the basis of the rain intensity distribution information provided by the meteorological radar; a constant determination means for determining a constant necessary for computation for calculating the rainfall from the rain intensity distribution information, on the basis of the rainfall estimated by the neural network and the rain intensity distribution information provided for estimation of the rainfall; and a rainfall calculation means for calculating the rainfall by performing computation with use of the constant which has been determined by the constant determination means on the basis of the rain intensity distribution information provided by the meteorological radar.

An earthquake is measured by seismographs installed at various parts of a country. On the basis of measured values, an earthquake center, an earthquake intensity, and an earthquake distribution are calculated.

### CITATION LIST

### Patent Literature

### [Patent Literature 1]

Japanese Patent Application Publication Tokukaihei No. 7-146375

### [Patent Literature 2]

Japanese Patent Application Publication Tokukai No. 2016-76887

### SUMMARY OF INVENTION

### Technical Problem

In the technique of Patent Literature 1 described above, installation of rain gauges is essential. Further, in general earthquake measurement, installation of seismographs is essential. That is, a conventional technique for carrying out inference and observation of an environmental state requires installation of a dedicated facility for that purpose, and expenses and labor for installation and management of the dedicated facility are required. Thus, there is a need for development of a technique for carrying out inference and observation of an environmental state without installation of such a dedicated facility.

An example aspect of the invention has been made in view of the above problems, and an example object thereof is to provide a technique for inferring an environmental state with use of signals for measuring a communication quality of spatial optical communication.

### Solution to Problem

A spatial optical communication system according to an example aspect of the invention includes: a plurality of optical transmitting and receiving apparatuses capable of constituting a mesh spatial optical communication network; and at least one processor, the at least one processor carrying out an analysis process of inferring, on the basis of reception signals of the optical transmitting and receiving apparatuses, a state of an air environment in at least one portion of an area in which the spatial optical communication network is formed, or a state of an installation ground of each of the optical transmitting and receiving apparatuses in the at least one portion of the area.

An analysis apparatus according to an example aspect of the invention includes at least one processor, the at least one processor carrying out: an acquisition process of acquiring reception signals of a plurality of optical transmitting and receiving apparatuses capable of constituting a mesh spatial optical communication network; and an analysis process of inferring, on the basis of the reception signals, a state of an air environment in at least one portion of an area in which the spatial optical communication network is formed, or a state of an installation ground of each of the optical transmitting and receiving apparatuses in the at least one portion of the area.

An example aspect of the invention includes a non-transitory storage medium storing a program for causing a computer to operate as the above analysis apparatus, the program causing the computer to carry out the acquisition process and the analysis process.

### Advantageous Effects of Invention

An example aspect of the invention makes it possible to infer an environmental state with use of signals for measuring a quality of spatial optical communication.

### BRIEF DESCRIPTION OF DRAWINGS

FIG. 1 is a block diagram illustrating a configuration of a spatial optical communication system according to a first example embodiment of the invention.

FIG. 2 is a diagram for showing a flow of a process in a spatial optical communication method that is carried out by the spatial optical communication system according to the first example embodiment of the invention.

FIG. 3 is a block diagram illustrating a configuration of a spatial optical communication system according to a second example embodiment of the invention.

FIG. 4 is a diagram schematically illustrating an aspect of communication between communication units of optical transmitting and receiving apparatuses in the spatial optical communication system according to the second example embodiment of the invention.

FIG. 5 is a diagram for showing a flow of a process in a spatial optical communication method that is carried out by the spatial optical communication system according to the second example embodiment of the invention.

FIG. 6 is a diagram schematically illustrating an influence of raining in communication between communication units of optical transmitting and receiving apparatuses in the spatial optical communication system according to the second example embodiment of the invention.

FIG. 7 is a diagram schematically illustrating an influence of raining in communication between communication units of optical transmitting and receiving apparatuses in the spatial optical communication system according to the second example embodiment of the invention.

FIG. 8 is a block diagram illustrating a configuration of a variation of the spatial optical communication system according to a second example embodiment of the invention.

FIG. 9 is a block diagram illustrating a configuration of a spatial optical communication system according to a third example embodiment of the invention.

FIG. 10 is a diagram for showing a flow of a process in a spatial optical communication method that is carried out by the spatial optical communication system according to the third example embodiment of the invention.

FIG. 11 is a diagram schematically illustrating an influence of vibration (earthquake) in communication between communication units of optical transmitting and receiving apparatuses in the spatial optical communication system according to the third example embodiment of the invention.

FIG. 12 is a block diagram illustrating a computer hardware configuration, which is an example implementation of the spatial optical communication apparatus according to each of the foregoing example embodiments of the invention.

### DESCRIPTION OF EMBODIMENTS

### First Example Embodiment

The following description will discuss a first example embodiment of the present invention in detail with reference to the drawings. The present example embodiment is a basic form of example embodiments described later.

### (Configuration of Spatial Optical Communication System)

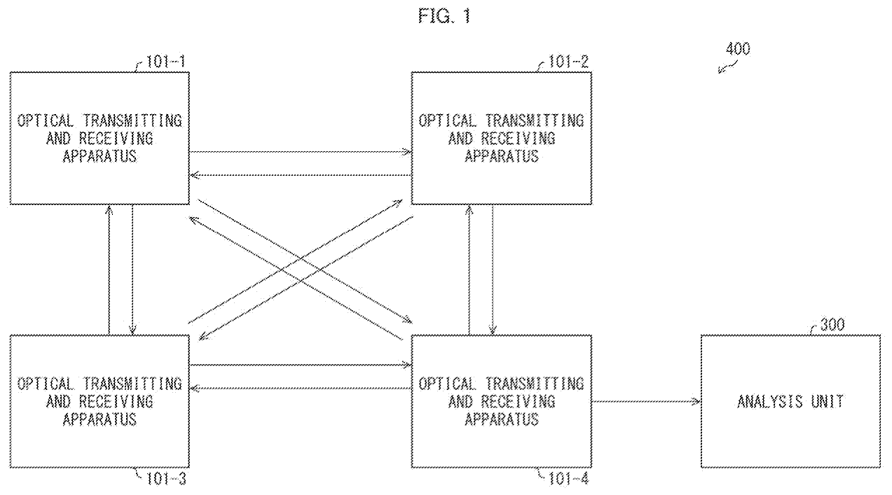

The following will discuss a configuration of a spatial optical communication system in accordance with the present example embodiment, with reference to FIG. 1. FIG. 1 is a block diagram illustrating a configuration of a spatial optical communication system 400. The spatial optical communication system 400 constitutes a mesh spatial optical communication network, including a plurality of optical transmitting and receiving apparatuses 101. The mesh spatial optical communication network refers to a spatial optical communication network in which a plurality of meshes are formed by spatial optical communication paths. FIG. 1 shows four optical transmitting and receiving apparatuses 101 as an example, but the number of the optical transmitting and receiving apparatuses 101 is not limited to four. Further, the spatial optical communication system 400 includes an analysis unit 300. The analysis unit 300 infers, on the basis of reception signals of the optical transmitting and receiving apparatuses 101, a state of an air environment in at least one portion of an area in which the spatial optical communication network is formed or a state of an installation ground of each of the optical transmitting and receiving apparatuses 101 in the at least one portion of the area.

### (Configuration of Optical Transmitting and Receiving Apparatus)

A plurality of optical transmitting and receiving apparatuses 101-1 to 101-4 (which may be referred to simply as optical transmitting and receiving apparatus 101 in a case where there is no need to specify any of the optical transmitting and receiving apparatuses 101-1 to 100-4) are an example implementation of optical transmitting and receiving apparatuses in claims.

The plurality of optical transmitting and receiving apparatuses 101-1 to 101-4 each carry out two-way communication with use of an optical communication medium between the optical transmitting and receiving apparatuses so as to form a mesh communication network. The optical communication medium transmitted from each of the optical transmitting and receiving apparatuses 101 is a directional optical communication medium. Specific examples of the optical communication medium include high frequency electromagnetic waves each having a frequency of approximately 10 GHz or higher, but the example embodiment is not limited to the specific examples. The high frequency electromagnetic waves may include millimeter waves, submillimeter waves, infrared light, visible light, and ultraviolet light.

For example, the optical transmitting and receiving apparatus 101-1 to 101-4 each use the high frequency electromagnetic waves as the directional communication medium (described earlier) for communication by directing and transmitting the high frequency electromagnetic waves in a predetermined angle range. In one example of a specific configuration that allows the optical transmitting and receiving apparatuses 101-1 to 101-4 to direct the high frequency electromagnetic waves, the optical transmitting and receiving apparatuses 101-1 to 101-4 include:
a beamforming antenna for directing and transmitting millimeter waves or submillimeter waves in a predetermined angle range;
a collimator for collimating infrared light, visible light, or ultraviolet light;
a laser oscillator for generating a laser of infrared light, visible light, or ultraviolet light;
a modulator that modulates a laser by changing a phase of a liquid crystal; and the like. However, the specific configuration does not limit the present example embodiment.

When the optical transmitting and receiving apparatus 101-1 to 101-4 direct and transmit the high frequency electromagnetic waves each serving as the communication medium, the communication medium has an increased energy density. This allows for communication with a more distant communication destination with use of the communication medium.

### (Analysis Unit 300)

The analysis unit 300 is an example implementation of at least one processor that carries out an analysis process in the claims.

The analysis unit 300 acquires, for example, a reception signal from each of the optical transmitting and receiving apparatuses 101. In this case, the analysis unit 300 is also an example implementation of at least one processor that carries out an acquisition process in the claims. However, the analysis unit 300 is not limited to such an example implementation. The analysis unit 300 may acquire, from a control unit that controls communication of each of the optical transmitting and receiving apparatuses 101, a signal (information) that indicates a spatial optical communication quality measured by the control unit acquiring the reception signal of each of the optical transmitting and receiving apparatuses 101. Alternatively, in one example, the analysis unit 300 can acquire the reception signal or a signal indicative of reception quality, via a communication network that is installed between the analysis unit 300 and the optical transmitting and receiving apparatuses or between the analysis unit 300 and the control unit.

The wording “at least one portion of the area” that is a target of inference of various states by the analysis unit 300 may be any of the following areas: an entire area covered by the spatial optical communication network formed by the four optical transmitting and receiving apparatuses 101-1 to 101-4 illustrated as an example in FIG. 1; an area which is a portion of the entire area; or an area of the spatial optical communication network covered by, for example, two optical transmitting and receiving apparatuses 101 (e.g., the optical transmitting and receiving apparatuses 101-1 and 101-2).

The analysis unit 300 infers, as the state of the air environment, for example, at least one selected from the group consisting of a rain state (the presence/absence of rain, and intensity of rain), the presence/absence or amount of a matter(s) (ultrafine particles, dust, and/or the like) suspended in the air, and temperature. In one example, the analysis unit 300 analyzes a reception level, which is an example of a quality of the spatial optical communication between the optical transmitting and receiving apparatuses 101-1 and 101-2.

In one example, in a case where the reception level is analyzed, the analysis unit 300 infers the rain state in a space constituted between these optical transmitting and receiving apparatuses, on the basis of the following: whether or not the amount of beam that could be received by an optical transmitting and receiving apparatus (for example, the optical transmitting and receiving apparatus 101-2) on a receiving side has been decreased from the amount of beam that has been transmitted from an optical transmitting and receiving apparatus (for example, the optical transmitting and receiving apparatus 101-1) on a transmitting side; and how much the beam is decreased.

Apart from the reception level, the analysis unit 300 can infer the state of the air environment with use of a bit error rate. In analysis on the basis of the bit error rate, the rain state in the space constituted between optical transmitting and receiving apparatuses is inferred on the basis of whether or not the bit error rate has increased and how much the beam is increased.

The analysis unit 300 can infer the state of the installation ground of the optical transmitting and receiving apparatus 101 in place of the above-described inference of the state of the air environment. However, the analysis unit 300 is not limited to such an implementation, and it is possible to infer the state of the installation ground of the optical transmitting and receiving apparatus 101, in addition to the above-described inference of the state of the air environment.

The analysis unit 300 infers, as the state of the installation ground of the optical transmitting and receiving apparatus 101, one selected from the group consisting of the following: the presence/absence or magnitude of an earthquake; the presence/absence and magnitude of a landslide; and the presence/absence and magnitude of ground subsidence. In one example, the analysis unit 300 extracts, from the reception signal, a vibration component of the installation ground of the optical transmitting and receiving apparatus 101. In one example, the vibration component can be extracted from the reception signal by a filtering process. Further, the analysis unit 300 can estimate the magnitude of an earthquake from the magnitude of the vibration component thus extracted. Further, a landslide and/or ground subsidence is inferred by detecting, by frequency analysis, a step response of displacement at an instant of the occurrence of the landslide or the ground subsidence. It is also possible to infer, from this inference and the rain state, a landslide and/or ground subsidence caused by rain.

Note that the vibration component extracted by the analysis unit 300 corresponds to a relative vibration component between the optical transmitting and receiving apparatus 101 on the transmitting side and the optical transmitting and receiving apparatus 101 on the receiving side.

In brief, the spatial optical communication system 400 in accordance with the present example embodiment is configured to be a spatial optical communication system including: a plurality of optical transmitting and receiving apparatuses capable of constituting a mesh spatial optical communication network; and an analysis unit which infers, on the basis of reception signals of the optical transmitting and receiving apparatuses, a state of an air environment in at least one portion of an area in which the spatial optical communication network is formed, or a state of an installation ground of each of the optical transmitting and receiving apparatuses in the at least one portion of the area. This allows the spatial optical communication system 400 to be a system for carrying out spatial optical communication and also to be capable of inferring, on the basis of the reception signal of the spatial optical communication, a state of an air environment or a state of an installation ground of each of the optical transmitting and receiving apparatuses 101. The present example embodiment can thus provide an example advantage that it is possible to infer these states on the basis of signals used in spatial optical communication without need for a dedicated facility (for example, a rain gauge or an seismograph) for inferring and measuring the state of the air environment or the state of the installation ground. Therefore, it is possible to suppress cost required for installation and management of the dedicated facility.

In other words, the present example embodiment here is configured to be an analysis apparatus including: an acquisition unit that acquires reception signals of a plurality of optical transmitting and receiving apparatuses capable of constituting a mesh spatial optical communication network; and an analysis unit that infers, on the basis of the reception signals, a state of an air environment in at least one portion of an area in which the spatial optical communication network is formed, or a state of an installation ground of each of the optical transmitting and receiving apparatuses in the at least one portion of the area. Therefore, it is possible to provide an analysis apparatus that achieves the above-described example advantage.

### (Flow of Analysis Method)

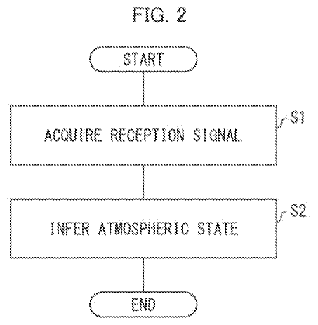

The following will discuss an analysis method for analyzing the above-described state of the air environment or the above-described state of the installation ground with use of the spatial optical communication system in accordance with the present example embodiment, with reference to FIG. 2. The analysis method includes: an acquisition step (S1) of acquiring reception signals of a plurality of optical transmitting and receiving apparatuses capable of constituting a mesh spatial optical communication network; and an analysis step (S2) that infers, on the basis of the reception signals acquired in the acquisition step, a state of an air environment in at least one portion of an area in which the spatial optical communication network is formed, or a state of an installation ground of each of the optical transmitting and receiving apparatuses in the at least one portion of the area. The following will further discuss a flow of the analysis method.

The acquisition process (S1) may be carried out by the analysis unit 300 which includes the acquisition unit as described above, or the control unit described above.

In the analysis step (S2), in one example, the analysis unit 300 acquires a signal (reception level or bit error rate) pertaining to the quality of the spatial optical communication measured by the control unit in the step S1 described above, and analyzes the state of the air environment in the at least one portion of the area. Note that as described above, the analysis unit 300 can infer, in step S2, the state of the installation ground of the optical transmitting and receiving apparatus 101. Since analysis of the state of the air environment and inference of the state of the installation ground have been described earlier, descriptions thereof are omitted here.

As described above, the present example embodiment employs a configuration of the analysis method that includes: an acquisition step of acquiring reception signals of a plurality of optical transmitting and receiving apparatuses capable of constituting a mesh spatial optical communication network; and an analysis step of inferring, on the basis of the reception signals acquired in the acquisition step, a state of an air environment in at least one portion of an area in which the spatial optical communication network is formed, or a state of an installation ground of each of the optical transmitting and receiving apparatuses in the at least one portion of the area. Thus, the analysis method in accordance with the present example embodiment makes it possible to infer, on the basis of the reception signal of the spatial optical communication, the state of the air environment or the state of the installation ground of each of the optical transmitting and receiving apparatuses 101. The present example embodiment can thus provide an example advantage that it is possible to infer these states on the basis of signals used in spatial optical communication without need for a dedicated facility (for example, a rain gauge or an seismograph) for inferring and measuring the state of the air environment or the state of the installation ground. Therefore, it is possible to suppress cost required for installation and management of the dedicated facility.

### Second Example Embodiment

The following description will discuss a second example embodiment of the present invention, with reference to the drawings. Note that members having functions identical to those of the respective members described in the first example embodiment are given respective identical reference numerals, and descriptions of those members will be omitted as appropriate.

### (Configuration of Spatial Optical Communication System)

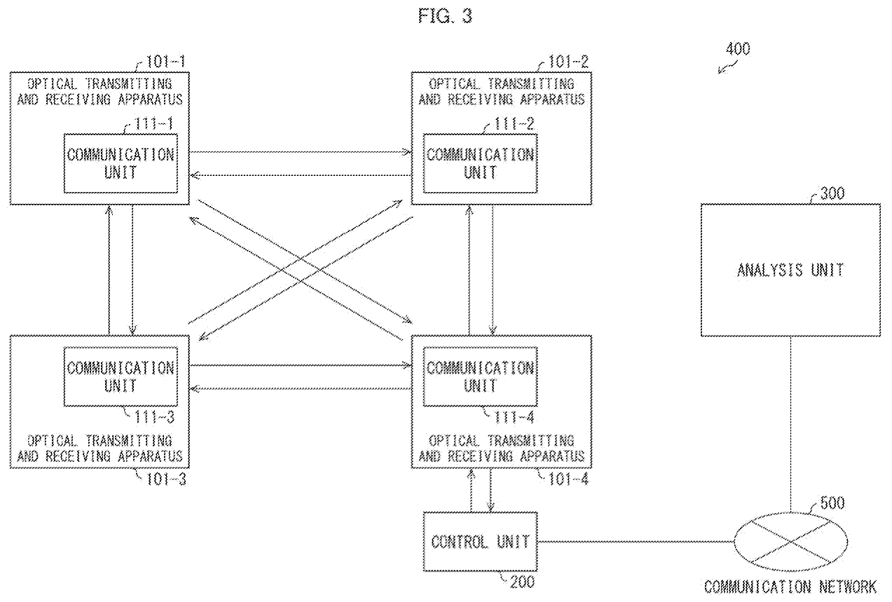

The following will discuss a configuration of a spatial optical communication system including a spatial optical communication apparatus in accordance with the present example embodiment, with reference to FIG. 3. FIG. 3 is a block diagram illustrating a configuration of a spatial optical communication system 400. The spatial optical communication system 400 includes a plurality of optical transmitting and receiving apparatuses 101-1 to 101-4 equipped with communication units 111-1 to 111-4, respectively. Further, the spatial optical communication system 400 includes a control unit 200. The control unit 200 measures a quality of spatial optical communication with use of a reception signal of each of the optical transmitting and receiving apparatuses 101. The spatial optical communication system 400 includes an analysis unit 300. The analysis unit 300 infers, on the basis of the quality of the spatial optical communication, a state of an air environment in at least one portion of an area in which the spatial optical communication network is formed. Note that although FIG. 3 illustrates four optical transmitting and receiving apparatuses 101-1 to 101-4 as an example and also illustrates an example in which the four optical transmitting and receiving apparatuses constitute a mesh spatial optical communication network, the number of the optical transmitting and receiving apparatuses is not limited to this configuration. Note that spatial optical communication between the first optical transmitting and receiving apparatus 101-1 and the second optical transmitting and receiving apparatus 101-2 will be mainly described below. In the following description, the first optical transmitting and receiving apparatus 101-1 is a transmitting side apparatus and the second optical transmitting and receiving apparatus 101-2 is a receiving side apparatus. Note that: the transmitting side apparatus and the receiving side apparatus are not limited to the above first and second optical transmitting and receiving apparatuses 101-1 and 101-2; the third optical transmitting and receiving apparatuses 101-3 and the fourth optical transmitting and receiving apparatuses 101-4 can be included in the transmitting/receiving side apparatuses; and the optical transmitting and receiving apparatuses 101-1 to 101-4 can be configured to be identical to each other.

### (First Optical Transmitting and Receiving Apparatus 101-1)

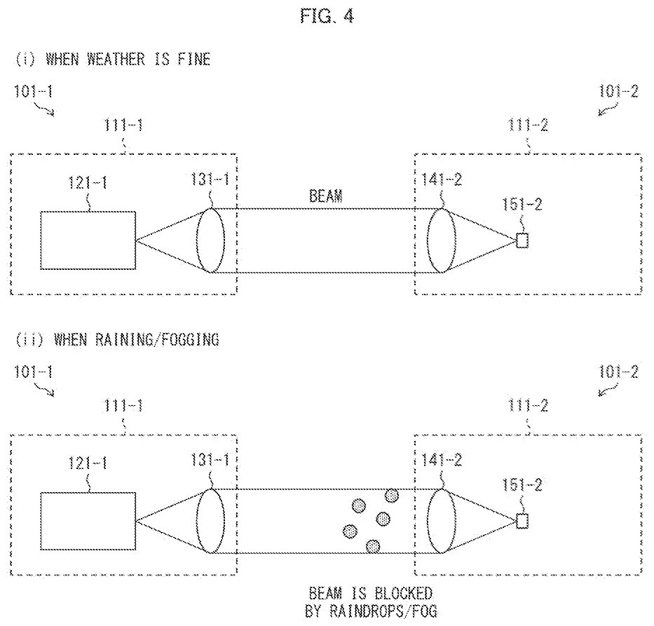

FIG. 4 is a diagram that schematically illustrating a configuration of each of the communication units 111-1 and 111-2 of the first optical transmitting and receiving apparatus 101-1 and the second optical transmitting and receiving apparatus 101-2 illustrated in FIG. 3, respectively, and that schematically illustrates states of spatial optical communication between the communication units 111-1 and 111-2. The communication unit 111-1 of the first optical transmitting and receiving apparatus 101-1 includes a laser light source 121-1 and a collimator lens 131-1 as illustrated in FIG. 4. Laser light emitted from the laser light source 121-1 enters the collimator lens 131-1 and is then emitted to the outside of the communication unit 111-1. In other words, the laser light source 121-1 and the collimator lens 131-1 can be said to constitute a transmission unit. In one example, the laser light emitted from the laser light source 121-1 can be, for example, light having a wavelength of 1550 nm. Note, however, that the wavelength is not limited to this but can be a wavelength in a range of 400 nm to 1600 nm.

### (Second Optical Transmitting and Receiving Apparatus 101-2)

The communication unit 111-2 of the second optical transmitting and receiving apparatus 101-2 includes a condensing lens 141-2 and a photodiode 151-2. The laser light emitted from the communication unit 111-1 of the first optical transmitting and receiving apparatus 101-1 is incident on the condensing lens 141-2, condensed, and received by the photodiode 151-2. In other words, the condensing lens 141-2 and the photodiode 151-2 can be said to constitute a receiving unit. Note that since each of the optical transmitting and receiving apparatuses 101 have the same configuration as described above, the communication unit 111-2 of the second optical transmitting and receiving apparatus 101-2 includes a configuration identical to the transmission unit in the communication unit 111-1 of the first optical transmitting and receiving apparatus 101-1. Similarly, the communication unit 111-1 of the first optical transmitting and receiving apparatus 101-1 includes a configuration identical to the receiving unit in the communication unit 111-2 of the second optical transmitting and receiving apparatus 101-2.

### (Control Unit 200)

The control unit 200 is an example implementation of at least one processor that carries out a control process in the claims.

The control unit 200 acquires a reception signal of each of the optical transmitting and receiving apparatuses 101. That is, in the present example embodiment, the control unit 200 is an example implementation of at least one processor that carries out an acquisition process in the claims. Note that acquisition of the reception signal is not limited to an example in which the control unit 200 acquires the reception signal directly from each of the optical transmitting and receiving apparatuses 101, but can be configured, for example, such that the control unit 200 acquires, via another optical transmitting and receiving apparatus 101-4, the reception signal of the optical transmitting and receiving apparatus 101-2 illustrated in FIG. 1.

The control unit 200 measures the quality of the spatial optical communication with use of the reception signal of each of the optical transmitting and receiving apparatuses 101. The quality of spatial optical communication measured with use of the reception signal of each of the optical transmitting and receiving apparatuses 101 can be a well-known communication quality in a case where spatial optical communication is carried out. In one example, the quality can be a reception level and/or a bit error rate, and a period in which the reception level changes.

Note that in a case where each of the optical transmitting and receiving apparatuses 101 has a function of acquiring the quality of spatial optical communication, the control unit 200 may acquire the quality of the spatial optical communication from each of the optical transmitting and receiving apparatuses 101. In other words, it can be said that in this case, the control unit 200 has a function of collecting the “quality of spatial optical communication” acquired from each of the optical transmitting and receiving apparatuses 101. Further, in this case, the quality of the spatial optical communication obtained by a certain optical transmitting and receiving apparatus 101 may be acquired by the control unit 200 via another optical transmitting and receiving apparatus 101. This makes it possible to decrease an amount of data in comparison with an example aspect in which the control unit 200 acquires, via another optical transmitting and receiving apparatus 101, the reception signal as it is from each of the optical transmitting and receiving apparatus 101.

In order that each of the optical transmitting and receiving apparatuses 101 can normally carry out spatial optical communication in the spatial optical communication network, the control unit 200 may control each of the optical transmitting and receiving apparatuses 101 on the basis of the quality measured with use of the reception signal. In one example, the control unit 200 classifies each predetermined period into a “time for communication” or a “time for analysis”. Then, in a case where the communication quality is poor, the control unit 200 controls, in the “time for communication”, switches a path or controls a power of a laser and/or a sensitivity of a receiver.

### (Analysis Unit 300)

The analysis unit 300 infers, on the basis of the quality of the spatial optical communication which is measured by the control unit 200, a state of an air environment in at least one portion of an area in which the spatial optical communication network is formed. Note that the acquisition of the quality of the spatial optical communication by the analysis unit 300 from the control unit 200 may be in an example aspect in which the quality is directly acquired by the analysis unit 300 from the control unit 200 or may be in an example aspect in which the quality is acquired by the analysis unit 300 from the control unit 200 via a communication network 500 illustrated in FIG. 3.

The analysis unit 300 infers, as the state of the air environment, for example, at least one selected from the group consisting of:
rain state (the presence/absence of raining, and intensity of rain);
the presence/absence or amount of a matter(s) (ultrafine particles, dust, and/or the like) suspended in the air; and
temperature.

FIG. 4 illustrates an example aspect in which the analysis unit 300 infers a rain state. FIG. 4 shows, on an upper side, a state in which the air environment is optimal in a space constituted between the communication unit 111-1 of the first optical transmitting and receiving apparatus 101-1, which is on the transmitting side, and the communication unit 111-2 of the second optical transmitting and receiving apparatus 101-2, which is on the receiving side. FIG. 4 shows, on a lower side, a state in a case where it is raining (similar in the case of fogging) in the space constituted between the communication unit 111-1 and the communication unit 111-2. The state in which the air environment is optimal refers to a state in which the weather is clear and there is no air pollution. In such a state in which the air environment is optimal (the upper side in FIG. 4), the beam of the laser light reaches the receiving side in a favorable manner. In contrast, in a case where in the space constituted between the communication unit 111-1 and the communication unit 111-2, it is raining (similar in the case of fogging) (the lower side of FIG. 4), a portion of the beam of the laser light being transmitted from the transmitting side to the receiving side is blocked by raindrops or fog. Thus, the analysis unit 300 infers the rain state in the space constituted between the communication unit 111-1 and the communication unit 111-2, on the basis of whether the amount of beam received on the receiving side has been decreased from the amount of beam transmitted from the transmitting side and how much the beam has been decreased.

Note that the control unit 200 determines whether or not the amount of the beam received on the receiving side has been decreased from the amount of the beam transmitted from the transmitting side, and how much the beam has been decreased. For example, the control unit 200 determines a reception level of each of the optical transmitting and receiving apparatuses in order to control spatial optical communication. The reception level indicates whether or not the amount of the beam received on the receiving side has been decreased from the amount of the beam transmitted from the transmitting side, and how much the beam has been decreased. Thus, the analysis unit 300 infers a rain (fog) state by acquiring the reception level that is measured by the control unit 200.

The presence/absence or amount of a matter(s) (such as ultrafine particles, dust and/or the like) suspended in the air also influences the amount of the beam transmitted from the transmitting side (i.e., reception level). Thus, the analysis unit 300 can also infer the presence/absence or amount of the matter(s) (ultrafine particles, dust, and/or the like) suspended in the air. Further, air fluctuation due to the temperature in the space constituted between the communication unit 111-1 and the communication unit 111-2 also influences the amount of the beam transmitted from the transmitting side. Thus, the analysis unit 300 can also infer the temperature.

In one example, the reception level is set to “100” in a case where the weather is clear and there is no air pollution. Then, assume a case where the reception level actually measured by the control unit 200 is 75. In one example, in a case where the analysis unit 300 is configured to generate an inference result that it is raining if the reception level is 80 or less and to generate an inference result that it is not raining if the reception level is more than 80, the analysis unit 300 generates the reference result that it is raining on the basis of the reception level of “75” actually measured.

Furthermore, in inference of rain, the analysis unit 300 can provide a state class of rainfall such as light rain at a reception level of “70 to 80”, heavy rain at a reception level of “50 to less than 70”, or disaster-level rain at a reception level of “50 or less”. In this case, on the basis of the above-described reception level of “75” actually measured, the analysis unit 300 generates an inference result that indicates light rain.

The inference result outputted by the analysis unit 300 may be outputted to the outside of the spatial optical communication system 400 (FIG. 3) or may be displayed on a display apparatus (not shown) included in the spatial optical communication system 400. Further, the control unit 200 can acquire the inference result thus outputted, and can use the inference result for control of spatial optical communication.

Note that in order for the analysis unit 300 to acquire, from the control unit 200, a signal indicative of the reception quality, the signal may be acquired via the communication network 500 that is provided between the control unit 200 and the analysis unit 300.

The above description has discussed a configuration in which the analysis unit 300 carries out analysis on the basis of a communication quality of a reception signal in each of the optical transmitting and receiving apparatuses 101. Note, however, that the present example embodiment is not limited to this configuration. The analysis unit 300 may carry out analysis on the basis of another indicator based on a reception signal in each of the optical transmitting and receiving apparatuses 101, for example, reception signals in a predetermined period.

In brief, the spatial optical communication system 400 according to the present example embodiment includes: a plurality of optical transmitting and receiving apparatuses capable of constituting a mesh spatial optical communication network; a control unit that measures, with use of a reception signal of each of the optical transmitting and receiving apparatuses, a quality (reception level, bit error rate) of spatial optical communication and controls each of the optical transmitting and receiving apparatuses on the basis of the quality; and an analysis unit that infers, on the basis of the quality, a state of an air environment (for example, rain state) in at least one portion of an area in which the spatial optical communication network is formed. This allows the spatial optical communication network 400 to be a system for carrying out spatial optical communication and also to be capable of inferring a state of an air environment on the basis of a signal (reception level) indicative of the quality of the spatial optical communication. The present example embodiment can thus provide an example advantage that it is possible to infer the state of the air environment on the basis of signals used in spatial optical communication without need for a dedicated facility (for example, a rain gauge) for inferring and measuring the state of the air environment. Therefore, it is possible to suppress cost required for installation and management of the dedicated facility.

### (Flow of Process in Spatial Optical Communication System)

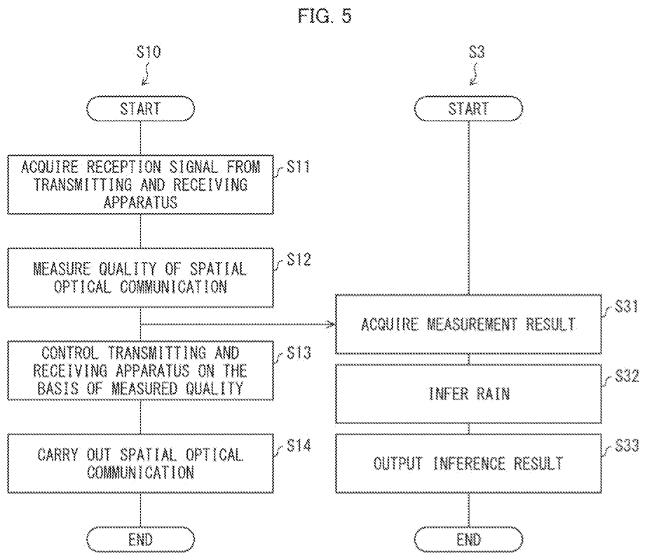

The following will discuss a flow of a process in the spatial optical communication system in accordance with the present example embodiment with reference to FIG. 5. FIG. 5 is a flowchart showing the flow of the process. The flowchart includes a flow (S10) of a process that is carried out by the control unit 200 associated with control of the spatial optical communication, and a flow (S3) of a process that is carried out by the analysis unit 300 described earlier.

The process flow of the spatial optical communication system includes the following steps as illustrated in FIG. 5: a control step (S10) of measuring a quality of spatial optical communication with use of a reception signal of each of optical transmitting and receiving apparatuses 101 and controlling each of the optical transmitting and receiving apparatuses 101 on the basis of the quality; and an analysis step (S3) of inferring, with use of the quality, a state of an air environment in at least one portion of an area in which the spatial optical communication network is formed.

### (Control Process)

The control process (S10) includes steps S11, S12, S13, and S14 described below.

### (Step S11)

First, in step S11, the control unit 200 acquires a reception signal of each of the optical transmitting and receiving apparatuses (acquisition process). Since specific details of the process here have been described earlier, a description thereof is omitted here.

### (Step S12)

In a next step S12, the control unit 200 measures a quality of spatial optical communication with use of the reception signal that is acquired in step S11. Since specific details of the process here have also been described earlier, a description thereof is omitted here.

### (Step S13)

In a next step S13, the control unit 200 controls each of the optical transmitting and receiving apparatuses 101 on the basis of the quality of the spatial optical communication that is measured in step S12.

### (Step S14)

In a next step S14, spatial optical communication is carried out between the optical transmitting and receiving apparatuses 101 that are controlled in the step S13.

### (Analysis Process)

The analysis process (S3) includes steps S31, S32, S33, and S34, which will be described below.

### (Step S31)

First, in step S31, the analysis unit 300 acquires a signal (reception level) pertaining to the quality of the spatial optical communication that is measured by the control unit 200 in step S12 described above.

### (Step S32)

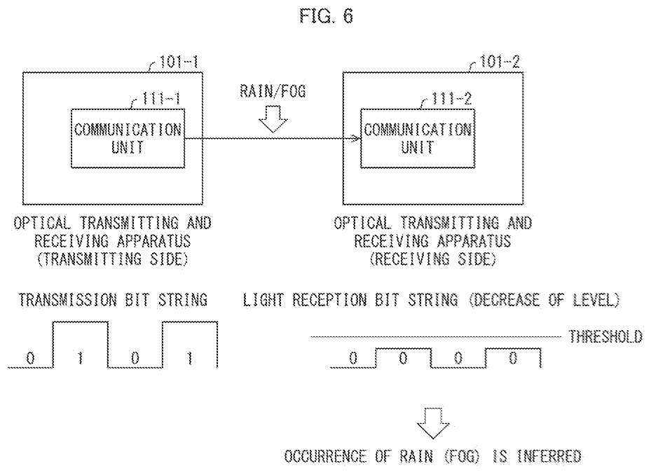

In a next step S32, the analysis unit 300 analyzes (infers) a state of an air environment (rain) in the above-described at least one portion of the area. In one example, in step S32, the reception level acquired in step S13 is compared with a reception level threshold. The reception level threshold may be stored in the analysis unit 300, or alternatively may be stored in a configuration capable of performing communication via the communication network 500. FIG. 6 is a diagram schematically illustrating the reception level and the reception level threshold. FIG. 6 shows a transmission bit string of a transmission signal (laser light) transmitted from the communication unit 111-1 of the optical transmitting and receiving apparatus 101-1 on the transmitting side, and a reception bit string of a signal received in the communication unit 111-2 of the optical transmitting and receiving apparatus 101-2 on the receiving side. A comparison between the transmission bit string and the reception bit string reveals that the reception level is decreased and that the reception bit string is below the reception level threshold. The analysis unit 300 infers the presence/absence of rain (fog) in such a comparison with the threshold. A plurality of such reception level thresholds may be provided so as to be associated with respective levels of rain. Since a relationship between the reception level and the level of rain is exemplified in the above description, a description thereof is omitted here.

### (Step S33)

In a next step S33, the analysis unit 300 outputs a result of analysis (inference) in the above-described step S32.

As described above, in the present example embodiment, the reception level is determined as the quality of the spatial optical communication in the control step (S10), and in the analysis step (S3), the state of the air environment is inferred with use of the reception level. Thus, the method according to the present example embodiment makes it possible to achieve a system that can be a system for carrying out spatial optical communication and that also can infer the state of the air environment with use of the signal (reception signal) for measuring the quality of the spatial optical communication. The present example embodiment can thus provide an example advantage that it is possible to infer the state of the air environment on the basis of signals used in spatial optical communication without need for a dedicated facility (for example, a rain gauge) for inferring and measuring the state of the air environment. Therefore, it is possible to suppress cost required for installation and management of the dedicated facility.

### (First Variation)

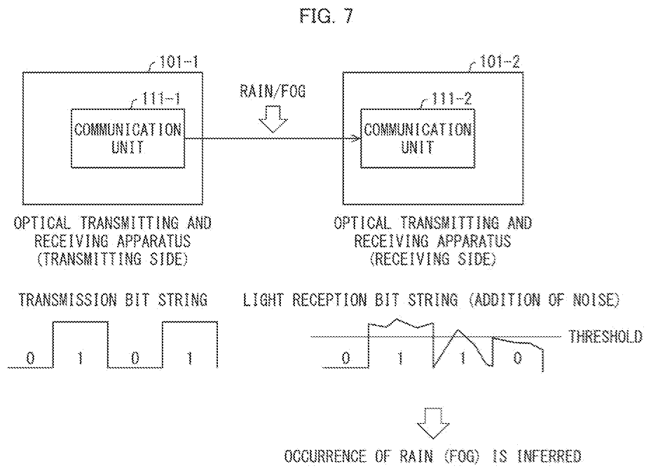

In the example described above, rain (fog) is inferred by determining, with use of a reception level as the quality of spatial optical communication, a decrease in reception level as illustrated in FIG. 6. However, embodiments of the present invention are not limited to this configuration. For example, in a case where it is raining (fogging) in an area between the communication units 111-1 and 111-2, the reception signal may be in a state in which noise is added to the transmission signal. FIG. 7 shows a reception bit string to which noise is added. This can be measured by the control unit 200 as a bit error rate. Thus, in the present variation, the analysis unit 300 acquires a bit error rate from the control unit 200, in place of step S32 described above. The analysis unit 300 may infer the occurrence of rain (fog) by determining, on the basis of the bit error rate, an increase in the bit error rate.

### (Second Variation)

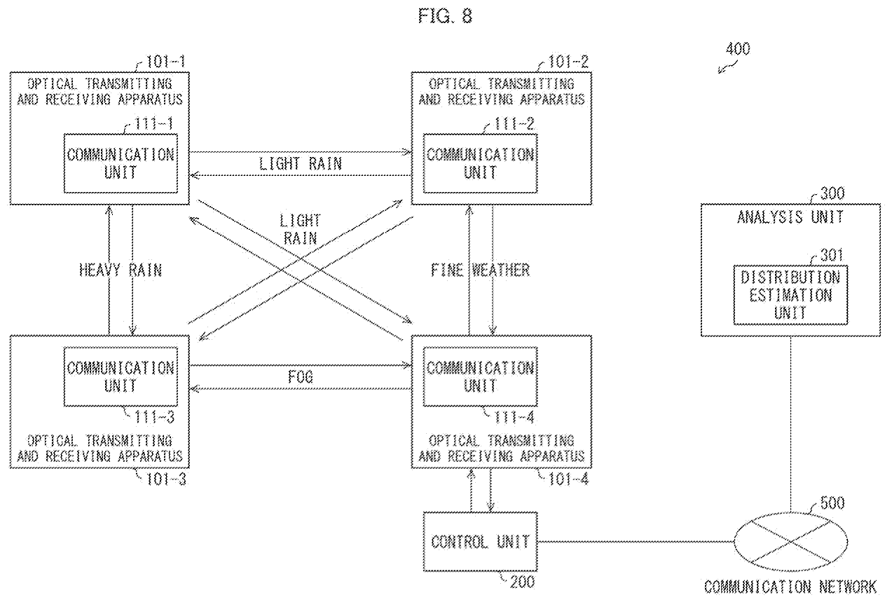

In the example described above, the analysis unit 300 infers, for example, the rain state in the area between the first optical transmitting and receiving apparatus 101-1 on the transmitting side and the second optical transmitting and receiving apparatus 101-2 on the receiving side. However, the analysis unit 300 is not limited to this configuration, and may include a distribution estimation unit 301 that estimates a distribution of the state of the air environment over a wide range as illustrated in FIG. 8.

The distribution estimation unit 301 acquires inference results of rain states each inferred between respective pairs of the optical transmitting and receiving apparatuses 101 forming the mesh spatial optical communication network. Thus, it is possible to estimate a distribution of the rain state in an installation area of the mesh spatial optical communication network. On the basis of a distribution estimation result outputted by the distribution estimation unit 301, locations and a distribution of the following areas in the installation area can be determined as illustrated in FIG. 8: a partial area of heavy rain, a partial area of light rain, a partial area of fine weather (no rain), and a partial area where fog occurs.

Furthermore, rain prediction can be made by continuously estimating such a distribution by the distribution estimation unit 301. In brief, the distribution information estimated can be used as information equivalent to a known rain cloud radar (precipitation radar) by analyzing the distribution information in a time series. In one example, a 1 km square area is defined as a wide area. Furthermore, in one example, 100 optical transmitting and receiving apparatuses can be arranged in a 1 km square area so as to be dispersedly located in the area so that the mesh spatial optical communication is configured.

Note that the optical transmitting and receiving apparatuses 101 of the spatial optical communication system may be arranged such that optical transmitting and receiving apparatuses 101 nearest to each other are spaced apart from each other by, for example, 50 m to 100 m. Note that the first optical transmitting and receiving apparatus 101-1 and the second optical transmitting and receiving apparatus 101-2 illustrated in FIG. 3 may not be located closest to each other. For example, one or more optical transmitting and receiving apparatuses 101 may be disposed between the first optical transmitting and receiving apparatus 101-1 and the second optical transmitting and receiving apparatus 101-2 illustrated in FIG. 3.

### Third Example Embodiment

The following description will discuss a third example embodiment of the present invention, with reference to the drawings. Note that members having functions identical to those of the respective members described in the first example embodiment are given respective identical reference numerals, and descriptions of those members will be omitted as appropriate.

### (Configuration of Spatial Optical Communication System)

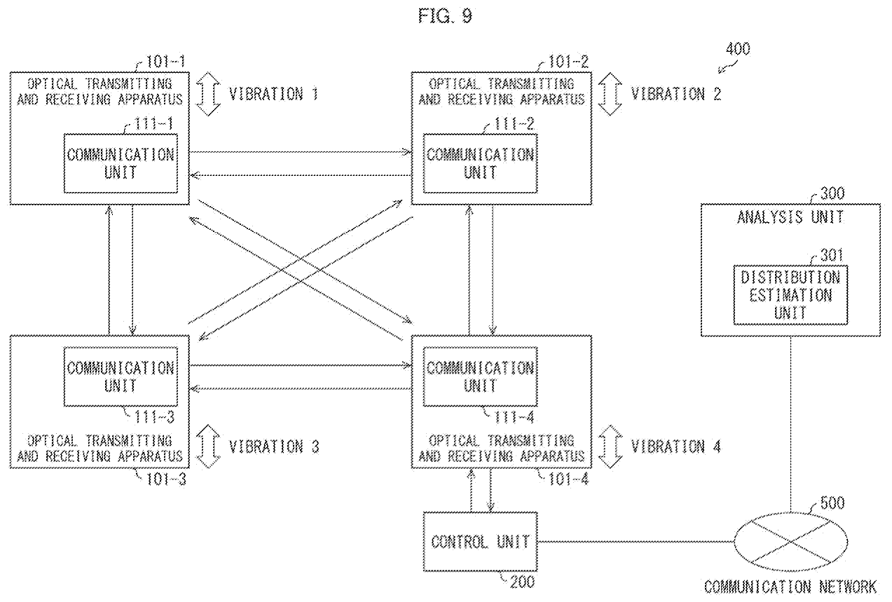

The following will discuss a configuration of a spatial optical communication system including a spatial optical communication apparatus in accordance with the present example embodiment, with reference to FIG. 9. FIG. 9 is a block diagram illustrating a configuration of a spatial optical communication system 400. Respective configurations of a plurality of optical transmitting and receiving apparatuses 101-1 to 101-4 and a control unit 200 included in the spatial optical communication system 400 are identical to those described in the second example embodiment described above. Thus, descriptions thereof are omitted here.

### (Analysis Unit 300)

Also, with regard to a configuration of an analysis unit 300, some descriptions whose content overlap the content of descriptions in the first example embodiment or the second example embodiment will be omitted. The analysis unit 300 infers, on the basis of a reception signal of each of the optical transmitting and receiving apparatuses 101, a state of an installation ground of each of the optical transmitting and receiving apparatuses 101 configured in at least one portion of an area in which the spatial optical communication network is formed. In one example, in the present example embodiment, a vibration state of a ground of the at least one portion of the area is inferred. Note that the state of the installation ground may be inferred in combination with the state of the air environment that is inferred by the analysis unit 300 according to the second example embodiment described earlier.

### (Flow of Process in Spatial Optical Communication System)

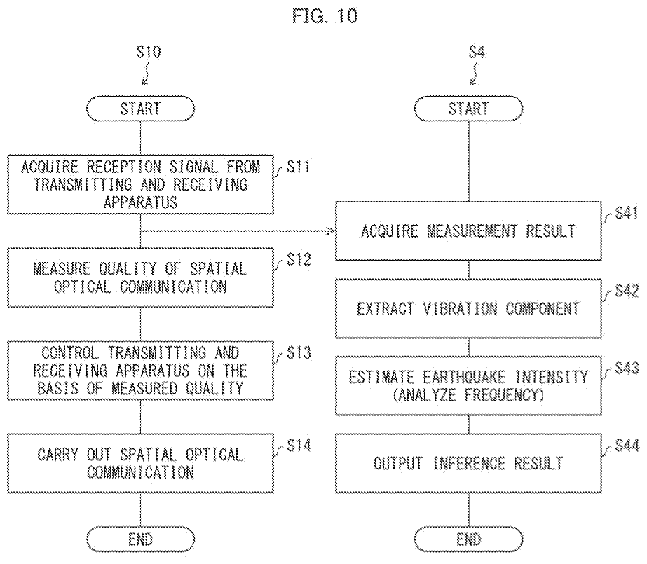

The following will discuss a flow of a process in the spatial optical communication system in accordance with the present example embodiment, with reference to FIG. 10. FIG. 10 is a flowchart showing the flow of the process. The flowchart includes a flow (S10) of a process associated with control of spatial optical communication, and a flow (S4) of a process that is carried out by the analysis unit 300 described earlier.

The process flow of the spatial optical communication system includes the following steps as illustrated in FIG. 10: a control step (S10) of measuring a quality of spatial optical communication with use of a reception signal of each of optical transmitting and receiving apparatuses 101 and controlling each of the optical transmitting and receiving apparatuses 101 on the basis of the quality; and an analysis step (S4) of inferring, with use of the reception signal, a state of an installation ground of the optical transmitting and receiving apparatus 101 in at least one portion of an area in which the spatial optical communication network is formed.

Since the control process (S10) includes steps S11, S12, S13, and S14 described in the second example embodiment described earlier, descriptions thereof are omitted here.

The analysis process (S4) includes steps S41, S42, S43, and S44 described below.

### (Step S41)

First, in step S41, the analysis unit 300 acquires a reception signal acquired by the control unit 200 in step S11 described above (acquisition process).

### (Step S42)

In a next step S42, the analysis unit 300 extracts, from the reception signal acquired, only a vibration frequency component specific to an earthquake wave by a filtering process.

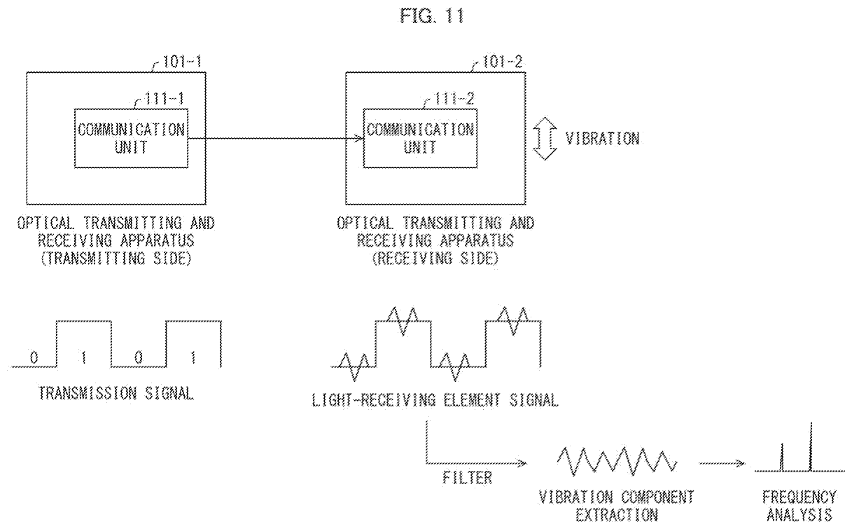

Note here that FIG. 11 schematically illustrates a state in which vibration (i.e., an earthquake) is occurring in a ground on which, of a communication unit 111-1 of the first optical transmitting and receiving apparatus 101-1, which is on a transmitting side, and a communication unit 111-2 of the second optical transmitting and receiving apparatus 101-2, which is on a receiving side, the second optical transmitting and receiving apparatus 101-2 is installed. In a case where an earthquake occurs and the second optical transmitting and receiving apparatus 101-2 that is on the receiving side vibrates as illustrated in FIG. 11, a vibration having a frequency specific to the earthquake wave occurs in the reception signal. In step S42, in order to determine the presence/absence and magnitude of the vibration of the frequency from the received signal, the analysis unit 300 extracts, from the acquired reception signal, only the vibration frequency component specific to the earthquake wave by the filtering process.

### (Step S43)

In a next step S43, the analysis unit 300 carries out frequency analysis with use of the vibration component extracted in step S42 described above. The analysis unit 300 infers/estimates, by the frequency analysis, the presence/absence of the occurrence of an earthquake and an intensity of the earthquake.

Note that the filtering process in step S42 is carried out by applying a fast Fourier transform to data obtained by sampling the reception signal by an A/D converter and analyzing the frequency component thereof. For example, in a case where only a vibration component having a vibration frequency of 0.5 to 5 Hz, which indicates a feature of an earthquake wave, is extracted by the filtering process, it can be inferred that an earthquake wave that is the P wave is generated if the vibration component extracted is propagating at 5 km/s to 7 km/s on a mesh and an earthquake wave that is the S wave is generated if the extracted vibration component propagates at 3 km/s to 4 km/s (step S43). Since the P wave arrives, as a preliminary tremor, earlier than the S wave which corresponds to a large shaking that will subsequently arrive, it is also possible to predict arrival of the S wave by detecting arrival of the P wave.

Note that the frequency analysis in step S43 may be carried out by each of the optical transmitting and receiving apparatuses 101 and/or the control unit 200. Furthermore, the analysis unit 300 may infer/estimate the presence/absence of the occurrence of an earthquake and an intensity of the earthquake, from a result of the frequency analysis transmitted from each of the optical transmitting and receiving apparatuses 101 and/or the control unit 200.

### (Step S44)

In a next step S44, the analysis unit 300 outputs a result of analysis (inference) in the above-described step S43.

As described above, an analysis method in accordance with the present example embodiment employs a configuration including the following steps: an acquisition step (S41) of acquiring a reception signal of each of optical transmitting and receiving apparatuses; and an analysis step (S4) of inferring, on the basis of the reception signal, a state of an installation ground of each of the optical transmitting and receiving apparatuses in at least one portion of an area in which the spatial optical communication network is formed. In this configuration, the analysis step (S4) detects a vibration component with use of the reception signal and infers/estimates the presence/absence and magnitude of an earthquake. The present example embodiment makes it possible achieve a system that can be a system for carrying out spatial optical communication and that also can infer, on the basis of the reception signal of the spatial optical communication, a state of an installation ground of each of the optical transmitting and receiving apparatuses. The present example embodiment can thus provide an example advantage that it is possible to infer a state of an installation ground of an optical transmitting and receiving apparatus on the basis of signals used in spatial optical communication without need for a dedicated facility (for example, an seismograph) for inferring and measuring the state of the installation ground. Therefore, it is possible to suppress cost required for installation and management of the dedicated facility.

### [Software Implementation Example]

The functions of part of or all of the analysis unit 300 of the spatial optical communication system 400 or the functions of part or all of the control unit 200 and the analysis unit 300 of the spatial optical communication system 400 can be realized by hardware such as an integrated circuit (IC chip) or can be alternatively realized by software.

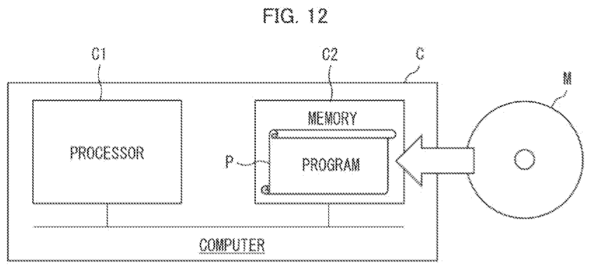

In the latter case, the analysis unit 300 of the spatial optical communication system 400 or the analysis unit 300 and the control unit 200 of the spatial optical communication system 400 is/are realized by, for example, a computer that executes instructions of a program that is software realizing the foregoing functions. FIG. 12 illustrates an example of such a computer (hereinafter referred to as “computer C”). The computer C includes at least one processor C1 and at least one memory C2. In the memory C2, a program P for causing the computer C to operate as a control system of the spatial optical communication system is stored. In the computer C, the processor C1 reads the program P from the memory C2 and executes the program P, so that the functions of the analysis unit 300 of the spatial optical communication system 400 or the analysis unit 300 and the control unit 200 of the spatial optical communication system 400 is/are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

A spatial optical communication system including:
a plurality of optical transmitting and receiving apparatuses capable of constituting a mesh spatial optical communication network; and
an analysis unit that infers, on the basis of reception signals of the optical transmitting and receiving apparatuses, a state of an air environment in at least one portion of an area in which the spatial optical communication network is formed, or a state of an installation ground of each of the optical transmitting and receiving apparatuses in the at least one portion of the area.

The above configuration allows the spatial optical communication system to be a system for carrying out spatial optical communication and also to be capable of inferring, on the basis of reception signals of the optical transmitting and receiving apparatuses which carry out the spatial optical communication, a state of an air environment or a state of an installation ground. The above configuration can thus provide an example advantage that it is possible to infer these states on the basis of signals used in spatial optical communication without need for a dedicated facility (for example, a rain gauge) for inferring and measuring the state of the air environment or the state of the installation ground. Therefore, it is possible to suppress cost required for installation and management of the dedicated facility.

### (Supplementary Note 2)

The spatial optical communication system according to supplementary note 1, wherein the analysis unit infers a rain state.

According to the above configuration, measurement by a rain gauge is unnecessary, so that cost for installation and management of the rain gauge can be suppressed.

### (Supplementary Note 3)

The spatial optical communication system according to supplementary note 1 or 2, wherein the analysis unit infers a vibration state of a ground in the at least one portion of the area.

According to the above configuration, measurement by a seismograph is unnecessary, so that cost for installation and management of the seismograph can be suppressed.

### (Supplementary Note 4)

The spatial optical communication system according to any one of supplementary notes 1 to 3, further including a control unit that measures, with use of a reception signal of each of the optical transmitting and receiving apparatuses, a quality of spatial optical communication of each of the optical transmitting and receiving apparatuses; and the analysis unit inferring the state of the air environment or the state of the installation ground on the basis of the quality of the spatial optical communication.

According to the above configuration, it is possible to infer the state of the air environment or the state of the installation ground by employing a signal indicating the quality of spatial optical communication.

### (Supplementary Note 5)

The spatial optical communication system according to supplementary note 4, wherein the quality of the spatial optical communication is at least one selected from the group consisting of a reception level of the reception signal and a bit error rate of the reception signal.

According to the above configuration, it is possible to infer the state of the air environment or the state of the installation ground by employing at least one selected from the group consisting of a reception level of the reception signal and a bit error rate of the reception signal.

### (Supplementary Note 6)

The spatial optical communication system according to supplementary note 2, wherein the analysis unit estimates, on the basis of the rain state, a rainfall distribution in the area in which the spatial optical communication network is formed.

According to the above configuration, it is possible to estimate a rainfall distribution without rainfall measurement and analysis with use of a rain gauge.

### (Supplementary Note 7)

The spatial optical communication system according to supplementary note 3, wherein the analysis unit estimates, on the basis of the vibration state, an earthquake distribution in the area in which the spatial optical communication network is formed.

According to the above configuration, it is possible to estimate an earthquake distribution without earthquake measurement and analysis with use of a seismograph.

### (Supplementary Note 8)

An analysis apparatus including:
an acquisition unit that acquires reception signals of a plurality of optical transmitting and receiving apparatuses capable of constituting a mesh spatial optical communication network; and
an analysis unit that infers, on the basis of the reception signals, a state of an air environment in at least one portion of an area in which the spatial optical communication network is formed, or a state of an installation ground of each of the optical transmitting and receiving apparatuses in the at least one portion of the area.

The above configuration makes it possible infer, on the basis of reception signals of the optical transmitting and receiving apparatuses which carry out spatial optical communication, a state of an air environment or a state of an installation ground. The above configuration can thus provide an example advantage that it is possible to infer these states on the basis of signals used in spatial optical communication without need for a dedicated facility (for example, a rain gauge) for inferring and measuring the state of the air environment or the state of the installation ground. Therefore, it is possible to suppress cost required for installation and management of the dedicated facility.

### (Supplementary Note 9)

An analysis method including:
an acquisition step of acquiring reception signals of a plurality of optical transmitting and receiving apparatuses capable of constituting a mesh spatial optical communication network; and
an analysis step of inferring, on the basis of the reception signals acquired in the acquisition step, a state of an air environment in at least one portion of an area in which the spatial optical communication network is formed, or a state of an installation ground of each of the optical transmitting and receiving apparatuses in the at least one portion of the area.

The above configuration makes it possible infer, on the basis of reception signals of the optical transmitting and receiving apparatuses which carry out spatial optical communication, a state of an air environment or a state of an installation ground. The above configuration can thus provide an example advantage that it is possible to infer these states on the basis of signals used in spatial optical communication without need for a dedicated facility (for example, a rain gauge) for inferring and measuring the state of the air environment or the state of the installation ground. Therefore, it is possible to suppress cost required for installation and management of the dedicated facility.

### (Supplementary Note 10)

A program for causing a computer to operate as the analysis apparatus according to supplementary note 8, the program causing the computer to function as each of the foregoing unit.

### (Supplementary Note 11)

An analysis system of a spatial optical communication system including a plurality of optical transmitting and receiving apparatuses capable of constituting a mesh spatial optical communication network, the analysis system including at least one processor,
the at least one processor carrying out:
an acquisition process of acquiring a reception signal of each of the plurality of optical transmitting and receiving apparatuses; and
an analysis process of inferring, on the basis of the reception signal, a state of an air environment in at least one portion of an area in which the spatial optical communication network is formed, or a state of an installation ground of each of the optical transmitting and receiving apparatuses in the at least one portion of the area.

Note that the analysis system may further include a memory, which may store a program for causing the processor to carry out each of the foregoing processes. The program may be stored in a computer-readable non-transitory tangible storage medium.

### REFERENCE SIGNS LIST

101, 101-1, 101-2, 101-3, 101-4 optical transmitting and receiving apparatus
111-1, 111-2 communication unit
121-1 laser light source
131-1 collimator lens
141-2 condensing lens
151-2 photodiode
200 control unit (acquisition unit)
300 analysis unit (acquisition unit, analysis apparatus)
301 distribution estimation unit
400 spatial optical communication system
500 communication network

1. A spatial optical communication system comprising:
a plurality of optical transmitting and receiving apparatuses capable of constituting a mesh spatial optical communication network; and
at least one processor,
the at least one processor carrying out an analysis process of inferring, on the basis of reception signals of the optical transmitting and receiving apparatuses, a state of an air environment in at least one portion of an area in which the spatial optical communication network is formed, or a state of an installation ground of each of the optical transmitting and receiving apparatuses in the at least one portion of the area.

2. The spatial optical communication system according to claim 1, wherein in the analysis process, the at least one processor infers a rain state.

3. The spatial optical communication system according to claim 1, wherein in the analysis process, the at least one processor infers a vibration state of a ground in the at least one portion of the area.

4. The spatial optical communication system according to claim 1, wherein:
the at least one processor further carries out a control process of measuring, with use of a reception signal of each of the optical transmitting and receiving apparatuses, a quality of spatial optical communication of each of the optical transmitting and receiving apparatuses; and
the at least one processor infers, in the analysis process, the state of the air environment or the state of the installation ground on the basis of the quality of the spatial optical communication.

5. The spatial optical communication system according to claim 4, wherein the quality of the spatial optical communication is at least one selected from the group consisting of a reception level of the reception signal and a bit error rate of the reception signal.

6. The spatial optical communication system according to claim 2, wherein in the analysis process, the at least one processor estimates, on the basis of the rain state, a rainfall distribution in the area in which the spatial optical communication network is formed.

7. The spatial optical communication system according to claim 3, wherein in the analysis process, the at least one processor estimates, on the basis of the vibration state, an earthquake distribution in the area in which the spatial optical communication network is formed.

8. An analysis apparatus comprising at least one processor,
the at least one processor carrying out:
an acquisition process of acquiring reception signals of a plurality of optical transmitting and receiving apparatuses capable of constituting a mesh spatial optical communication network; and
an analysis process of inferring, on the basis of the reception signals, a state of an air environment in at least one portion of an area in which the spatial optical communication network is formed, or a state of an installation ground of each of the optical transmitting and receiving apparatuses in the at least one portion of the area.

9. A non-transitory storage medium storing a program for causing a computer to operate as an analysis apparatus according to claim 8, the program causing the computer to carry out the acquisition process and the analysis process.
